(19) United States
(12) Patent Application Publication
(10) Pub. No.: US 2019/0335296 A1
(43) Pub. Date: Oct. 31, 2019

(54) A LOCATION-BASED SUBSCRIBER QUERY SYSTEM

(71) Applicant: TURKCELL TEKNOLOJÍ ARASTIRMA VE GELÍSTÍRME ANONÍM SÍRKETÍ, ISTANBUL (TR)

(72) Inventors: Caner ÇANAK, ISTANBUL (TR); Onur ÖNES, GEBZE, KOCAELI (TR)

(73) Assignee: TURKCELL TEKNOLOJÍ ARASTIRMA VE GELÍSTÍRME ANONÍM SÍRKETÍ, ISTANBUL (TR)

(21) Appl. No.: 16/471,116

(22) PCT Filed: Dec. 19, 2017
(86) PCT No.: PCT/TR2017/000139

§ 371 Date: Jun. 19, 2019

(30) Foreign Application Priority Data
Dec. 19, 2016 (TR) 2016/18872

(51) Int. Cl. H04W 4/021; H04W 4/14; H04W 4/029; H04W 64/00; H04W 8/18; H04W 24/08; G06F 16/242

(52) U.S. Cl. CPC H04W 4/021; H04W 4/14; H04W 4/029; G06F 16/2425; H04W 8/18; H04W 24/08; H04W 64/00

(57) ABSTRACT

The present invention relates to a system (1) for performing location-based queries by following up position information of mobile network subscribers continuously, thus detecting subscribers who have been in a certain location at a given time and informing over detected subscriber information.

### TECHNICAL FIELD

The present invention relates to a system for performing location-based queries by following up position information of mobile network subscribers continuously, thus detecting subscribers who have been in a certain location at a given time and informing over detected subscriber information.

### BACKGROUND OF THE INVENTION

Today, use of mobile devices and mobile communication networks shows a continuous increase. Mobile devices can obtain position information by means of signal exchanges which they carry out with mobile communication networks. Various services can be created for subscribers or various institutions by considering detected mobile device position information as position information of the subscriber because mobile devices are frequently situated together with the subscriber. These services are called as location based services (LBS).

Location based services provide lots of information and services to subscribers and institutions, they are essentially based upon characteristic of locating the subscriber.

Today, location-based services being used are services which are usually based on the basis of querying subscribers' position information instantly or a very short time ago and taking an action specific to the subscriber according to this position information or determining position information of a certain subscriber or subscribers instantly and then transmitting them to other institutions, services and which have limited capabilities.

The United States patent document no. US20110051665A1, an application in the state of the art, discloses a mobile device which determines its own position by means of network interaction and stores these position information locally as historical data.

The Japanese patent document no. JP2006262231, an application in the state of the art, discloses a system for confirming whether a person who should be in a disaster occurrence area is in it and his/her activities.

The United States patent document no. US2016295374, an application in the state of the art, discloses a system and method for positioning upon mobile device signals are used by network. Information is obtained about user's position by observing intervals of signals, which are received from user's device, for arriving the network. In the event that there is a plurality of base stations, an interpretation is carried out according to the difference among these base stations and position of the user's device is found by means of network data.

### SUMMARY OF THE INVENTION

An objective of the present invention is to realize a system for performing location-based queries by following up position information of mobile network subscribers continuously, thus detecting subscribers who have been in a certain location at a given time and informing over detected subscriber information.

### DETAILED DESCRIPTION OF THE INVENTION

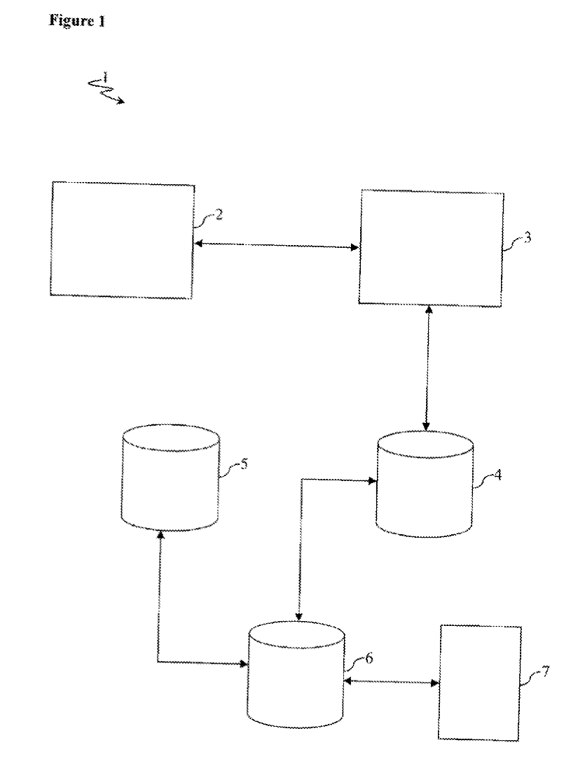

“A Location-Based Subscriber Query System” realized to fulfil the objective of the present invention is shown in the FIGURE attached, in which:
FIG. 1 is a schematic block diagram of the inventive system.

The components illustrated in the FIGURE are individually numbered, where the numbers refer to the following:
1. System
2. Positioning unit
3. Position information receiving unit
4. Position database
5. Location database
6. Position and location database
7. Query and information unit

A location-based subscriber query system (1) comprises:
at least one positioning unit (2) wherein mobile devices of subscribers are recorded on the mobile communication network instantly and/or which keeps and/or determines the cell information where they create traffic; at least one position information receiving unit (3) which receives the mobile device-based cell information kept and/or determined by the positioning unit (2) from the positioning unit (2) at periodical intervals and ensures that they are recorded in the form of historical data;
at least one position database (4) which is included within the position information receiving unit (3) and managed by the position information receiving unit (3), keeps the cell information received by the position information receiving unit (3) from the positioning unit (2) and the information about the coverage area of each cell in the form of historical data;
at least one location database (5) wherein the information about the pro-defined locations are recorded depending on the cell information where the location is present and the pro-defined location class information;
at least one position and location database (6) which is in communication with the position database (4) and the location database (5), matches the data inside the position database (4) with the data inside the location database (5) and records them on the basis of date and subscriber; and at least one query and information unit (7) which is in communication with the position and location database (6), can communicate with mobile devices of subscribers and carries out the related query transaction on the position and location database (6) by meeting the query demands received from the mobile device with the location class information and returns the results obtained in consequence of the query to the mobile device.

The positioning unit (2) included in the inventive system (1) is a unit wherein mobile devices of subscribers are recorded on the mobile communication network instantly and/or which keeps and/or determines the cell information where they create traffic. The positioning unit (2) can be one of the standard equipments included in the mobile communication network. In the preferred embodiment of the invention, the positioning unit (2) is a HLR (Home Location Register) member however it can be a unit with any structure such that it is generally defined in different embodiment of the invention.

The position information receiving unit (3) included in the inventive system (1) is a unit which receives the subscriber-based cell information kept and/or determined by the positioning unit (2) from the positioning unit (2) at periodical intervals and records them to the position database (4) in the form of historical data. The position information receiving unit (3) is a unit which is configured such that the information that it receives from the positioning unit (2) at periodical intervals and records in the form of historical data are stored in the position database (4) for a predetermined period of time.

The position database (4) included in the inventive system (1) is a unit which is in communication with the position and location database (6), included within the position information receiving unit (3) and managed by the position information receiving unit (3). The position database (4) records the subscriber-based cell information received by the position information receiving unit (3) from the positioning unit (2) and the information about the coverage area of each cell in the form of historical data.

The location database (5) included in the inventive system (1) is in communication with the position and location database (6). The information about the pre-defined locations are recorded inside the location database (5) depending on the cell information where the location is present and the pre-defined location class information. Inside the location database (5), for example, a stadium called as A is recorded depending on the information of B cell where it is located and the stadium class information that is C.

The position and location database (6) included in the inventive system (1) is in communication with the position database (4), the location database (5) and the query and information unit (7). The position and location database (6) matches the data inside the position database (4) with the data inside the location database (5) and records them on the basis of date and subscriber. The position and location database (6) carries out matching transaction depending on the cell identity that is common in the data inside the position database (4) and the data inside the location database (5).

The query and information unit (7) included in the inventive system (1) is in communication with the position and location database (6) and can communicate with mobile devices of subscribers. The query and information unit (7) carries out the related query transaction on the position and location database (6) by meeting the query demands received from the mobile device with the location class information, using the location class information and the subscriber information wherefrom query demand is received and sends the results obtained in consequence of the query to the mobile device. In the preferred embodiment of the invention, the subscriber information used by the query and information unit (7) in the query transaction is the MSISDN (Mobile Station International Subscriber Directory Number) information that is assigned to the subscriber by the mobile network operator providing service to the mobile device. The query and information unit (7) can communicate with mobile device over any communication channel included in the state of the art such as short message, interactive voice response, internet.

In one embodiment of the invention, the query and information unit (7) is in communication with the position database (4). In this embodiment, the query and information unit (7) connects to the position database (4) and the position and location database (6) periodically. The query and information unit (7) obtains the last position data where the subscribers are located from the position database (4) and thereupon determines the location visited by the subscriber frequently in this position from the records included inside the location database (5). The query and information unit (7) sends the information about the location visited by the subscriber frequently to the subscriber's mobile device depending on the last position data of the subscriber and thus offers the subscriber to visit the said location.

In an exemplary embodiment of the inventive location-based subscriber query system (1), the subscriber sends a short message such that “where was the last concert I went to” to a predetermined service number. The mobile communication network forwards this message reaching its private service number to the query and information unit (7). The query and information unit (7) carries out a query transaction on the position and location server (6) by connecting to the position and location server (6), using the MSISDN information wherefrom the concert and the short message is received and it ensures that an A location information reached as a result of a query transaction is sent to the mobile device over a short message channel together with the X history information such that the subscriber is in A location.

It is possible to develop various embodiments of the inventive system (1), the invention cannot be limited to examples disclosed herein and it is essentially according to claims.

1. A location-based subscriber query system (1) for performing location-based queries by following up position information of mobile network subscribers continuously, thus detecting subscribers who have been in a certain location at a given time and informing over detected subscriber information; comprising
at least one positioning unit (2) wherein mobile devices of subscribers are recorded on the mobile communication network instantly and/or which keeps and/or determines the cell information where they create traffic;
at least one position information receiving unit (3) which receives the mobile device-based cell information kept and/or determined by the positioning unit (2) from the positioning unit (2) at periodical intervals and ensures that they are recorded in the form of historical data;
at least one position database (4) which is included within the position information receiving unit (3) and managed by the position information receiving unit (3), keeps the cell information received by the position information receiving unit (3) from the positioning unit (2) and the information about the coverage area of each cell in the form of historical data; at least one location database (5) wherein the information about the pre-defined locations are recorded depending on the cell information where the location is present and the pre-defined location class information;
and characterized by
at least one position and location database (6) which is in communication with the position database (4) and the location database (5), matches the data inside the position database (4) with the data inside the location database (5) and records them on the basis of date and subscriber; and
at least one query and information unit (7) which is in communication with the position and location database (6), can communicate with mobile devices of subscribers and carries out the related query transaction on the position and location database (6) by meeting the query demands received from the mobile device with the location class information and returns the results obtained in consequence of the query to the mobile device.

2. A location-based subscriber query system (1) according to claim 1; characterized by the positioning unit (2) which is a unit wherein mobile devices of subscribers are recorded on the mobile communication network instantly and/or which keeps and/or determines the cell information where they create traffic.

3. A location-based subscriber query system (1) according to claim 1, characterized by the position information receiving unit (3) which is a unit that receives the subscriber-based cell information kept and/or determined by the positioning unit (2) from the positioning unit (2) at periodical intervals and records them to the position database (4) in the form of historical data.

4. A location-based subscriber query system (1) according to claim 1, characterized by the position information receiving unit (3) which is configured such that the information that it receives from the positioning unit (2) at periodical intervals and records in the form of historical data are stored in the position database (4) for a predetermined period of time.

5. A location-based subscriber query system (1) according to claim 1, characterized by the position database (4) which is in communication with the position and location database (6), included within the position information receiving unit (3) and managed by the position information receiving unit (3).

6. A location-based subscriber query system (1) according to claim 1, characterized by the position database (4) which records the subscriber-based cell information received by the position information receiving unit (3) from the positioning unit (2) and the information about the coverage area of each cell in the form of historical data.

7. A location-based subscriber query system (1) according to claim 1, characterized by the location database (5) which is in communication with the position and location database (6).

8. A location-based subscriber query system (1) according to claim 1, characterized by the location database (5) which records the information about the pre-defined locations inside itself depending on the cell information where the location is present and the pre-defined location class information.

9. A location-based subscriber query system (1) according to claim 1, characterized by the position and location database (6) which is in communication with the location database (5) and the query and information unit (7).

10. A location-based subscriber query system (1) according to claim 1, characterized by the position and location database (6) which matches the data inside the position database (4) with the data inside the location database (5) and records them on the basis of date and subscriber

11. A location-based subscriber query system (1) according to claim 10, characterized by the position and location database (6) which carries out matching transaction depending on the cell identity that is common in the data inside the position database (4) and the data inside the location database (5).

12. A location-based subscriber query system (1) according to claim 1, characterized by the query and information unit (7) which is in communication with the position and location database (6) and can communicate with mobile devices of subscribers.

13. A location-based subscriber query system (1) according to claim 1, characterized by the query and information unit (7) which carries out the related query transaction on the position and location database (6) by meeting the query demands received from the mobile device with the location class information, using the location class information and the subscriber information wherefrom query demand is received and sends the results obtained in consequence of the query to the mobile device.

14. A location-based subscriber query system (1) according to claim 13, characterized by the query and information unit (7) which uses MSISDN information that is assigned to the subscriber by the mobile network operator providing service to the mobile device as the subscriber information in the query transaction.

15. A location-based subscriber query system (1) according to claim 1, characterized by the query and information unit (7) which can communicate with mobile device over any communication channel such as short message, interactive voice response, internet.

16. A location-based subscriber query system (1) according to claim 1, characterized by the query and information unit (7) which is in communication with the position database (4).

17. A location-based subscriber query system (1) according to claim 1, characterized by the (2) which connects to the position database (4) and the position and location database (6) periodically, obtains the last position data where the subscribers are located from the position database (4) and determines the location visited by the subscriber frequently in this position from the records included inside the location database (6).

18. A location-based subscriber query system (1) according to claim 17, characterized by the query and information unit (7) which sends the information about the location visited by the subscriber frequently to the subscriber's mobile device depending on the last position data of the subscriber.
